(19) United States
(12) Patent Application Publication
(10) Pub. No.: US 2025/0104722 A1
(43) Pub. Date: Mar. 27, 2025

(54) METHOD AND DEVICE FOR ENCODING/DECODING AUDIO SIGNAL BASED ON DEQUANTIZATION THROUGH POTENTIAL DIFFUSION

(71) Applicants: Electronics and Telecommunications Research Institute, Daejeon (KR); The Trustees of Indiana University, Bloomington, IN (US)

(72) Inventors: Inseon JANG, Daejeon (KR); Woo-taek LIM, Daejeon (KR); Soo Young PARK, Daejeon (KR); Seung Kwon BEACK, Daejeon (KR); Jongmo SUNG, Daejeon (KR); Byeongho CHO, Daejeon (KR); Jung Won KANG, Daejeon (KR); Tae Jin LEE, Daejeon (KR); Minje KIM, Bloomington, IN (US); Haici YANG, Bloomington, IN (US)

(73) Assignees: Electronics and Telecommunications Research Institute, Daejeon (KR); The Trustees of Indiana University, Bloomington, IN (US)

(21) Appl. No.: 18/886,765

(22) Filed: Sep. 16, 2024

Related U.S. Application Data
(60) Provisional application No. 63/585,530, filed on Sep. 26, 2023.

(30) Foreign Application Priority Data
May 13, 2024 (KR) 10-2024-0062599

(51) Int. Cl. G10L 19/038; G10L 21/0208; G10L 25/30

(52) U.S. Cl. CPC G10L 19/038; G10L 21/0208; G10L 25/30

(57) ABSTRACT

A method and device for encoding/decoding an audio signal based on dequantization through potential diffusion are provided. The method of decoding an audio signal includes obtaining a discrete latent vector in which a speech signal is quantized and based on the discrete latent vector, outputting a continuous latent vector in which the discrete latent vector is dequantized.

### CROSS-REFERENCE TO RELATED APPLICATION

This application claims the benefit of U.S. Provisional Application No. 63/585,530, filed on Sep. 26, 2023, in the U.S. Patent and Trademark Office, and claims the benefit of Korean Patent Application No. 10-2024-0062599, filed on May 13, 2024, in the Korean Intellectual Property Office, the entire disclosures of which are incorporated herein by reference for all purposes.

### BACKGROUND

### 1. Field of the Invention

One or more embodiments relate to a method and device for encoding/decoding an audio signal based on dequantization through potential diffusion.

### 2. Description of the Related Art

A neural speech codec (NSC) has been developed to more effectively capture complex patterns in a speech signal. The NSC may be mainly classified into two types, for example, an end-to-end codec and a neural vocoder.

A generative model may be a model for generating data in the field of artificial intelligence. The generative model may generate new data based on previously provided data or may generate new samples by training distribution of provided data. The generative model is utilized in various fields and may be applied in image generation, natural language generation, and voice generation.

A diffusion model, an example of the generative model, is one of the recently emerged generative models and may use a diffusion process to approximate distribution of data. The diffusion model may gradually transform provided initial data to generate desired data.

The above description has been possessed or acquired by the inventor(s) in the course of conceiving the present disclosure and is not necessarily an art publicly known before the present application is filed.

### SUMMARY

Embodiments may provide technology of estimating a high bit rate continuous latent vector from a low bit rate discrete latent vector using a generative model to decode a compressed speech signal.

However, the technical aspects are not limited to the aforementioned aspects, and other technical aspects may be present.

According to an aspect, there is provided a method of processing a speech signal, the method including obtaining a discrete latent vector in which the speech signal is quantized and based on the discrete latent vector, outputting a continuous latent vector in which the discrete latent vector is dequantized.

The outputting of the continuous latent vector may include gradually up-sampling the discrete latent vector according to a plurality of layers included in a neural network.

The up-sampling of the discrete latent vector may include, based on the discrete latent vector and a first continuous latent vector corresponding to a first layer among the plurality of layers, estimating a second continuous latent vector corresponding to a second layer among the plurality of levels.

The estimating of the second continuous latent vector may include, based on the discrete latent vector and the first continuous latent vector, estimating noise in the first continuous latent vector and calculating the second continuous latent vector by removing the noise from the first continuous latent vector.

The method may further include generating a restored speech signal based on a continuous latent vector output through a layer of a highest level among the plurality of layers.

According to another aspect, there is provided an electronic device for processing a speech signal, the electronic device including a processor and a memory configured to store instructions, wherein the instructions, when executed by the processor, may cause the electronic device to obtain a discrete latent vector in which the speech signal is quantized and based on the discrete latent vector, output a continuous latent vector in which the discrete latent vector is dequantized.

The instructions, when executed by the processor, may cause the electronic device to gradually up-sample the discrete latent vector according to a plurality of layers included in a neural network.

The instructions, when executed by the processor, may cause the electronic device to, based on the discrete latent vector and a first discrete latent vector corresponding to a first level among the plurality of levels, estimate a second continuous latent vector corresponding to a second level among the plurality of levels.

The instructions, when executed by the processor, may cause the electronic device to, based on the discrete latent vector and the first continuous latent vector, estimate noise included in the first continuous latent vector and calculate the second continuous latent vector by removing the noise from the first continuous latent vector.

The instructions, when executed by the processor, may cause the electronic device to generate a restored speech signal based on a continuous latent vector output through a layer of a highest level among the plurality of layers.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a speech signal processing system according to an embodiment;

FIG. 2 is a diagram illustrating an encoder and a decoder shown in FIG. 1;

FIGS. 3A and 3B are diagrams illustrating a training method of the encoder and the decoder shown in FIG. 2;

FIG. 4 illustrates an example of a flowchart of a speech signal processing method according to an embodiment; and

FIG. 5 illustrates an example of an electronic device according to an embodiment.

### DETAILED DESCRIPTION

The following detailed structural or functional description is provided as an example only and various alterations and modifications may be made to the embodiments.

Accordingly, the embodiments are not construed as limited to the disclosure and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly the second component may also be referred to as the first component.

It should be noted that if one component is described as being “connected”, “coupled”, or “joined” to another component, a third component may be “connected”, “coupled”, and “joined” between the first and second components, although the first component may be directly connected, coupled, or joined to the second component.

The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms, including technical and scientific terms, used herein have the same meaning as commonly understood by one of ordinary skill in the art to which the present disclosure pertains. Terms, such as those defined in commonly used dictionaries, should be construed to have meanings matching with contextual meanings in the relevant art, and are not to be construed to have an ideal or excessively formal meaning unless otherwise defined herein.

Hereinafter, the embodiments will be described in detail with reference to the accompanying drawings. When describing the embodiments with reference to the accompanying drawings, like reference numerals refer to like components and a repeated description related thereto will be omitted.

FIG. 1 illustrates an example of a speech signal processing system according to an embodiment.

Referring to FIG. 1, a speech signal processing device may include an encoder 110 and a decoder 130. However, FIG. 1 is an example for describing the present disclosure, and the scope of the present disclosure should not be construed as being limited thereto. For example, the speech signal processing device 100 may include only one of the encoder 110 and the decoder 130.

Processing a speech signal may include compressing a speech signal and/or restoring a compressed speech signal to a signal before compression.

The encoder 110 may encode an input speech signal to generate a bit stream and may transmit (or output) the bit stream to the decoder 130.

The decoder 130 may decode the bitstream obtained (or received) from the encoder 110 to generate a restored speech signal.

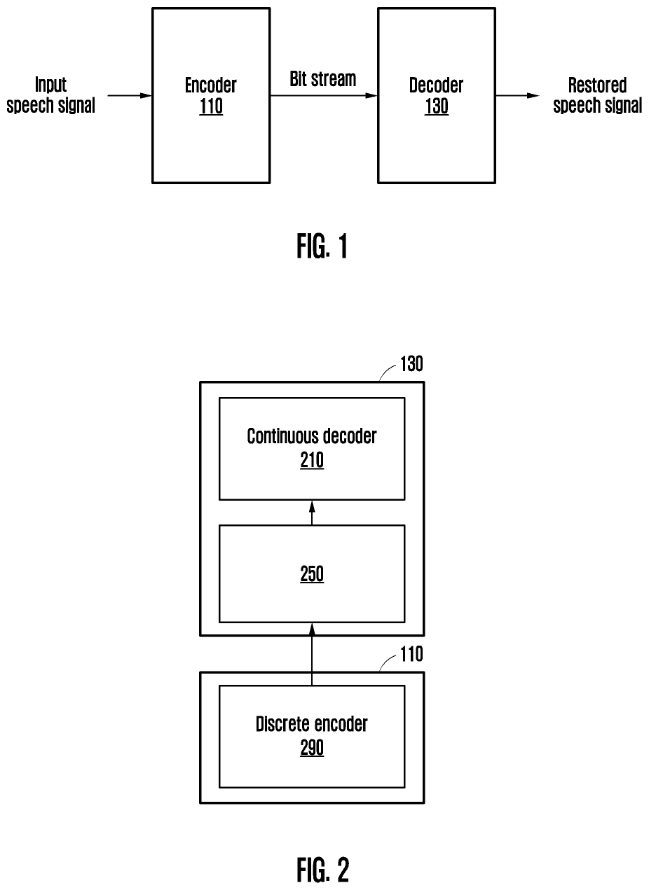

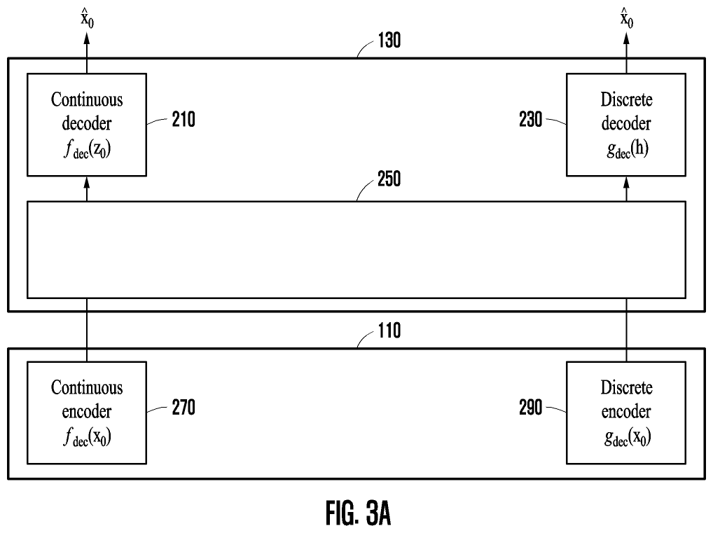

The specific configuration and operation of the encoder 110 and the decoder 130 are described in detail below with reference to FIG. 2.

FIG. 2 is a diagram illustrating an encoder and a decoder shown in FIG. 1.

Referring to FIG. 2, the encoder 110 may include a discrete encoder 290.

The decoder 130 may include a continuous decoder 210 and a generative model 250.

The encoder 110 may generate a bit stream in which a speech signal (e.g., the input speech signal of FIG. 1) is encrypted. The discrete encoder 290 may output a discrete latent vector based on the speech signal. The discrete latent vector is a vector in which the speech signal is quantized and may have a low bit rate. The discrete encoder 290 may be an auto encoder for training a discrete latent space [symbol] . The discrete encoder 290 may reduce a time-domain speech signal into the discrete latent space [symbol] to generate the discrete latent vector.

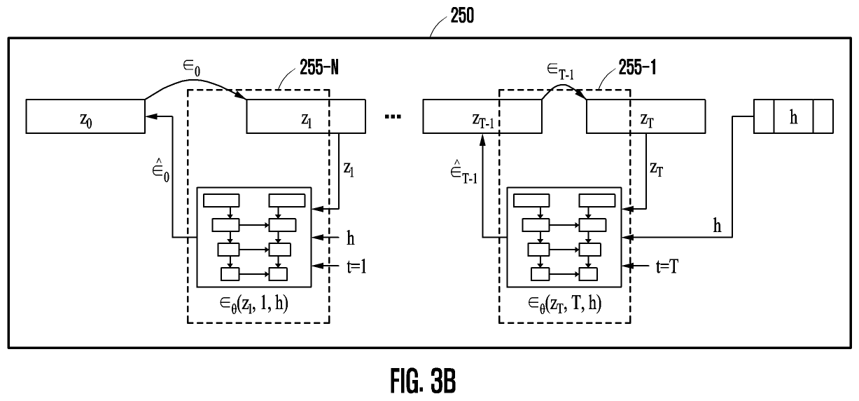

The discrete latent vector described above may include a latent vector of the discrete encoder 290 and/or a discrete decoder (e.g., a discrete decoder 230 of FIG. 3A) configured through end-to-end training in the field of neural speech codec (NSC) technology.

The decoder 130 may obtain (e.g., receive) a bit stream (e.g., the discrete latent vector) from the encoder 110.

The decoder 130 may generate a high-quality restored speech signal by using a low bit rate discrete latent vector. For example, the decoder 130 may generate a continuous latent vector from the discrete latent vector through the generative model 250 and may restore the continuous latent vector by the continuous decoder 210 to generate the high-quality restored speech signal.

Hereinafter, a training method of the encoder 110 and/or the decoder 130 is described in detail with reference to FIGS. 3A and 3B.

FIGS. 3A and 3B are diagrams illustrating a training method of the encoder and the decoder shown in FIG. 2.

Referring to FIG. 3A, training of a continuous encoder 270 and the continuous decoder 210, training of the discrete encoder 290 and the discrete decoder 230, and training of the generative model 250 may be performed independently.

The discrete encoder 290 may be trained to output a discrete latent vector based on a speech signal (e.g., the input speech signal of FIG. 1). A detailed description of the discrete latent vector is provided with reference to FIG. 2, and the description thereof is omitted herein.

The discrete decoder 230 may be trained to generate a first restored speech signal based on the discrete latent vector. The first restored speech signal is generated based on a low bit rate discrete latent vector and may have low quality.

The continuous encoder 270 may be trained to output a continuous latent vector based on a speech signal (e.g., the input speech signal of FIG. 1). The continuous latent vector may be a latent vector in which the discrete latent vector is dequantized. In addition, the continuous latent vector is a vector in which the speech signal is encrypted but not quantized and may have a high bit rate. The continuous encoder 270 may be an auto encoder for training a continuous latent space [symbol] . The continuous encoder 270 may reduce a time-domain speech signal into the continuous latent space [symbol] to generate the continuous latent vector. The continuous decoder 210 may obtain the continuous latent vector from the continuous encoder 270.

The continuous decoder 210 may be trained to generate a second restored speech signal based on the continuous latent vector. The second restored speech signal is generated based on a high bit rate continuous latent vector and may have high quality. The reason for the difference in quality between the first restored speech signal and the second restored speech signal may be that the discrete latent vector, in which an encrypted speech signal is quantized, has information (e.g., including information about speech features of the input speech signal in FIG. 1) less than the continuous latent vector.

The continuous latent vector described above may include a latent vector of the continuous encoder 270 and/or the continuous decoder 210 configured through end-to-end training in the field of NSC technology.

When training of the continuous encoder 270 and the continuous decoder 210 and training of the discrete encoder 290 and the discrete decoder 230 are completed, the continuous decoder 210 may be mounted on the encoder 110 and the discrete encoder 290 may be mounted on the decoder 130, as shown in FIG. 2. However, embodiments are not limited thereto.

Hereinafter, a training method of the generative model 250 is described.

Referring to FIG. 3B, the decoder 130 may use a discrete latent vector and a continuous latent vector for training the generative model 250. When the training of the generative model 250 is completed, the generative model 250 may generate the continuous latent vector based on the discrete latent vector.

The generative model 250 may refer to a neural network for producing a specific output (e.g., the continuous latent vector) based on an input condition (e.g., the discrete latent vector). The neural network may include a plurality of layers (e.g., layers 255-1 to 255-N).

The neural network (or an artificial neural network) may include a statistical training algorithm that mimics biological neurons in machine learning and cognitive science. The neural network may generally refer to a model having a problem-solving ability implemented through artificial neurons or nodes forming a network through synaptic connections where the strength of the synaptic connections is changed through learning.

A neuron of the neural network may include a combination of weights or biases. The neural network may include one or more layers, each including one or more neurons or nodes. The neural network may infer a result from a predetermined input by changing weights of the neurons through training.

The neural network may include a deep neural network (DNN). The neural network may include a convolutional neural network (CNN), a recurrent neural network (RNN), a perceptron, a multilayer perceptron, a feed forward (FF), a radial basis function (RBF) network, a deep feed forward (DFF), a long short-term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), a visual geometry group (VGG) network, and an attention network (AN).

Hereinafter, a method of training the generative model 250 is described in detail.

The generative model 250 may be trained to generate the continuous latent vector based on the discrete latent vector. For example, the generative model 250 may be implemented as a diffusion model to generate the continuous latent vector. The diffusion model may be a model trained to generate output based on an input condition through a Markov process. The Markov process may include a forward process and a reverse process. Hereinafter, a method of training the generative model 250 through the forward process and the reverse process is described.

For ease of description, terms are defined as follows. It is assumed that the layer 255-1 is the lowest level layer and levels increase as next operations are performed. For example, the layer 255-2 may be a layer one level higher than the layer 255-1. In addition, the continuous latent vector corresponding to a layer (any one of the layers 255-1 to 255-N) is assumed to be the continuous latent vector input to the layer based on the reverse process. This may be identical to the continuous latent vector output through a layer in the forward process. For example, a continuous latent vectors z_{T} may correspond to the layer 255-1.

In the forward process, a first continuous latent vector z0 may be progressively down-sampled according to the plurality of layers (e.g., the layers 255-1 to 255-N) included in the neural network (e.g., the generative model 250). For example, the first the continuous latent vector z0 may be input to the layer 255-N and may be added to noise ∈₀ (e.g. Gaussian noise) to become a second continuous latent vector z1. The second continuous latent vector z1 may also be input to a next layer (e.g., a layer one level lower than the layer 255-N) to become a third continuous latent vector z2 in substantially the same method as the first continuous latent vector z0 is down-sampled. When this method is performed repeatedly, an N-th continuous latent vector z_{T} may be generated. The N-th continuous latent vector z_{T} may be a latent vector converted into noise by adding noise N times (e.g., the number of times input to a layer (e.g., at least one of the layers 255-1 to 255-N)) to the first continuous latent vector z0. That is, in the forward process, noise may be added for each operation when the continuous latent vector is advanced to a next operation.

In the reverse process, a discrete latent vector h may be progressively up-sampled according to the plurality of layers (e.g., the layers 255-1 to 255-N) included in the neural network (e.g., the generative model 250). The discrete latent vector h may be up-sampled according to the plurality of layers to become the continuous latent vector z0. For example, the layer 255-1 may receive the discrete latent vector h and the continuous latent vector z_{T} as input and may estimate noise \hat{∈}_{T-1} (e.g. Gaussian noise) included in (or added to) the continuous latent vector z_{T}. The layer 255-1 may generate a continuous latent vector z_{T-1} by removing noise \hat{∈}_{T-1} estimated in the continuous latent vector z_{T}. When this method is performed repeatedly on the continuous latent vector z_{T} corresponding to the layer 255-1 as the level of layers is increased, the continuous latent vector z0 corresponding to the layer 255-N having the highest level may be calculated (or estimated). That is, when the discrete latent vector is advanced to a next operation in the reverse process, noise may be removed for each operation.

A parameter (e.g., ∈_{θ}(z_{T},T,h)) included in the generative model 250 may be trained through the forward process and/or the reverse process. A parameter may be for estimating noise in the continuous latent vector input for each layer. For example, parameters may be trained so that the difference between noise ∈_{T-1} to which the continuous latent vector z_{T-1} input to the layer 255-1 in the forward process is added and the noise \hat{∈}_{T-1} estimated in the layer 255-1 in the reverse process is minimized. The parameters may be trained through Equation 1 below.

$${{z}_{0} , t , h}_{} ( ‖ {ϵ}_{t} - {ϵ}_{θ} ( {z}_{t} , t , h ) ‖ ) \qquad [ Equation 1 ]$$

In Equation 1, [symbol] z₀,t,h denotes a loss function about noise, ∈ₜ denotes noise that is added to a t−1-th continuous latent vector input to a t-th layer in the forward process, and ∈_{θ}(zₜ,t,h) denotes a parameter for estimating noise in a t-th continuous latent vector input to the t-th layer in the reverse process.

When training of the generative model 250 is completed, the generative model 250 may generate the continuous latent vector z0 based on the discrete latent vector h. Hereinafter, the description thereof is provided in detail below.

The generative model 250 may gradually up-sample the discrete latent vector according to the plurality of layers included in the neural network. The generative model 250 may estimate a second continuous latent vector corresponding to a second layer among the plurality of layers (the layers 255-1 to 255-N), based on the discrete latent vector and a first continuous latent vector corresponding to a first layer among the plurality of layers (the layers 255-1 to 255-N). The first layer may be a layer with a level lower than the second layer. However, the first layer is not necessarily the layer 255-1 but may be any one of the plurality of layers (the layers 255-1 to 255-N). For example, the first layer may be a layer 255-n. Here, n may be an integer between 1 and N.

The generative model 250 may estimate noise in the first continuous latent vector based on the discrete latent vector and the first continuous latent vector. The generative model 250 may remove noise from the first continuous latent vector and may calculate the second continuous latent vector. This is described in detail in the reverse process above, so the description thereof is omitted hereinafter.

The generative model 250 may output a finally-generated continuous latent vector (e.g., a continuous latent vector output through the highest level layer among the plurality of layers (the layers 255-1 to 255-N)) to the continuous decoder 210. The continuous decoder 210 may generate a restored speech signal based on the finally-generated continuous latent vector.

The discrete encoder 290, the continuous decoder 210, and the generative model 250 may be mounted on an encoder (e.g., the encoder 110 of FIG. 2) and/or a decoder (e.g., the decoder 130 of FIG. 2) when training is completed. This is the same as that shown in FIG. 2, so the detailed description thereof is omitted herein.

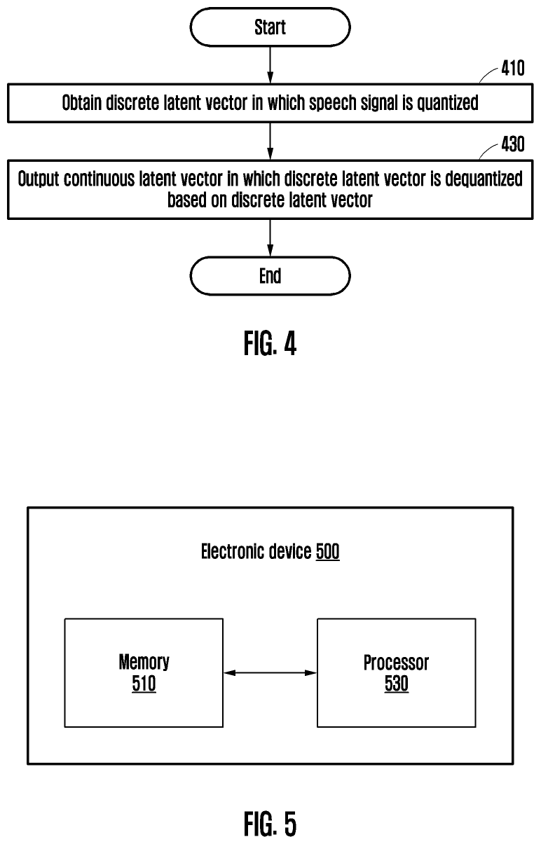

FIG. 4 illustrates an example of a flowchart of a speech signal processing method according to an embodiment.

Referring to FIG. 4, operations 410 and 430 may be performed sequentially but are not limited thereto. For example, two or more operations may be performed in parallel. Operations 410 and 430 may be substantially the same as the operation of the speech signal processing device (e.g., the speech signal processing device 100 of FIG. 1) described with reference to FIGS. 1 and 3B. Accordingly, further description thereof is not repeated herein.

In operation 410, the speech signal processing device 100 may obtain (e.g., receive) a discrete latent vector in which a speech signal is quantized.

In operation 430, the speech signal processing device 100 may output a continuous latent vector in which the discrete latent vector is dequantized based on the discrete latent vector.

FIG. 5 illustrates an example of an electronic device according to an embodiment.

Referring to FIG. 5, an electronic device 500 may include a memory 510 and a processor 530. The electronic device 500 may include the speech signal processing device 100 of FIG. 1. For example, the electronic device 500 may be a device including the decoder 130 of FIG. 1.

The memory 510 may store instructions (or programs) executable by the processor 530. For example, the instructions include instructions for performing an operation of the processor 530 and/or an operation of each component of the processor 530.

The memory 510 may be implemented as a volatile memory device or a non-volatile memory device.

The volatile memory device may be implemented as dynamic random-access memory (DRAM), static random-access memory (SRAM), thyristor RAM (T-RAM), zero capacitor RAM (Z-RAM), or twin transistor RAM (TTRAM).

The non-volatile memory device may be implemented as electrically erasable programmable read-only memory (EEPROM), flash memory, magnetic RAM (MRAM), spin-transfer torque (STT)-MRAM, conductive bridging RAM (CBRAM), ferroelectric RAM (FeRAM), phase-change RAM (PRAM), resistive RAM (RRAM), nanotube RRAM, polymer RAM (PoRAM), nano floating gate memory (NFGM), holographic memory, a molecular electronic memory device, or insulator resistance change memory.

The processor 530 may process data stored in the memory 510. The processor 530 may execute computer-readable code (e.g., software) stored in the memory 510, and instructions triggered by the processor 530.

The processor 530 may be a hardware-implemented data processing device having a circuit that is physically structured to execute desired operations. For example, the desired operations may include code or instructions in a program.

The hardware-implemented data processing device may include, for example, a microprocessor, a central processing unit (CPU), a processor core, a multi-core processor, a multiprocessor, an application-specific integrated circuit (ASIC), and a field-programmable gate array (FPGA).

The processor 510 may cause the electronic device 500 to perform one or more operations by executing the instructions and/or code stored in the memory 530. The operations performed by the electronic device 500 may be substantially the same as the operations performed by the speech signal processing device 100 described with reference to FIGS. 1 to 3 (e.g., a voice signal processing method performed by the speech signal processing device 100 and/or a training method of a neural network (e.g., the generative model 250 of FIG. 2) performed by the speech signal processing device 100). Accordingly, a repeated description thereof is omitted.

The components described in the embodiments may be implemented by hardware components including, for example, at least one digital signal processor (DSP), a processor, a controller, an ASIC, a programmable logic element, such as an FPGA, other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or collectively instruct or configure the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like. Examples of program instructions include both machine code, such as one produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, and/or replaced or supplemented by other components or their equivalents.

Therefore, other implementations, other embodiments, and equivalents to the claims are also within the scope of the following claims.

What is claimed is:

1. A method of processing a speech signal, the method comprising:
obtaining a discrete latent vector in which the speech signal is quantized; and
based on the discrete latent vector, outputting a continuous latent vector in which the discrete latent vector is dequantized.

2. The method of claim 1, wherein
the outputting of the continuous latent vector comprises gradually up-sampling the discrete latent vector according to a plurality of layers included in a neural network.

3. The method of claim 2, wherein
the up-sampling of the discrete latent vector comprises, based on the discrete latent vector and a first continuous latent vector corresponding to a first layer among the plurality of layers, estimating a second continuous latent vector corresponding to a second layer among the plurality of layers.

4. The method of claim 3, wherein
the estimating of the second continuous latent vector comprises:
based on the discrete latent vector and the first continuous latent vector, estimating noise in the first continuous latent vector; and
calculating the second continuous latent vector by removing the noise from the first continuous latent vector.

5. The method of claim 2, further comprising:
generating a restored speech signal based on a continuous latent vector output through a layer of a highest level among the plurality of layers.

6. An electronic device for processing a speech signal, the electronic device comprising:
a processor; and
a memory configured to store instructions,
wherein the instructions, when executed by the processor, cause the electronic device to:
obtain a discrete latent vector in which the speech signal is quantized; and
based on the discrete latent vector, output a continuous latent vector in which the discrete latent vector is dequantized.

7. The electronic device of claim 6, wherein
the instructions, when executed by the processor, cause the electronic device to:
gradually up-sample the discrete latent vector according to a plurality of layers included in a neural network.

8. The electronic device of claim 7, wherein
the instructions, when executed by the processor, cause the electronic device to:
based on the discrete latent vector and a first continuous latent vector corresponding to a first layer among the plurality of layers, estimate a second continuous latent vector corresponding to a second layer among the plurality of layers.

9. The electronic device of claim 8, wherein
the instructions, when executed by the processor, cause the electronic device to:
based on the discrete latent vector and the first continuous latent vector, estimate noise in the first continuous latent vector; and
calculate the second continuous latent vector by removing the noise from the first continuous latent vector.

10. The electronic device of claim 7, wherein
the instructions, when executed by the processor, cause the electronic device to:
generate a restored speech signal based on a continuous latent vector output through a layer of a highest level among the plurality of layers.
